(19) United States
(12) Patent Application Publication
(10) Pub. No.: US 2023/0249900 A1
(43) Pub. Date: Aug. 10, 2023

(54) CAPSULE AND SYSTEM FOR PREPARING A BEVERAGE

(71) Applicant: Koninklijke Douwe Egberts B.V., Utrecht (NL)

(72) Inventors: Richard John Andrews, Utrecht (NL); Gerbrand Kristiaan De Graaff, Hillegom (NL); Paul Alderson, Banbury (GB); Christian Solano Bermejo, Utrecht (NL)

(21) Appl. No.: 18/137,976

(22) Filed: Apr. 21, 2023

Related U.S. Application Data
(63) Continuation of application No. 16/629,543, filed on Jan. 8, 2020, now abandoned.

(30) Foreign Application Priority Data
Jul. 10, 2017 (NL) 2019220
Feb. 2, 2018 (NL) 2020374

(51) Int. Cl. B65D 85/804; A47J 31/36

(52) U.S. Cl. CPC B65D 85/8052; A47J 31/3623

(57) ABSTRACT

A capsule for preparing a beverage comprises a substantially rigid capsule body with a circumferential wall and a base wall that border an inner space filed with a beverage ingredient. An open filling side of the capsule at an end of the circumferential wall opposite the base wall is covered with a lid of fluid tight material. The lid is provided with a preformed outlet opening suitable for draining the prepared beverage from the inner space when the capsule is used in a beverage preparation device. The outlet opening is fluid tightly closed by a removable cover element extending over at least part of the lid.

### CROSS-REFERENCE TO RELATED APPLICATIONS

This application is a continuation of U.S. Pat. Application No. 16/629543, filed Jan. 8, 2020, which is a U.S. National phase application of International Application No. PCT/NL2018/050460, filed Jul. 10, 2018, which claims benefit from Netherlands Application 2019220, filed Jul. 10, 2017, and Netherlands Application 2020374, filed Feb. 2, 2018, which are each hereby incorporated herein by reference in their entirety.

### FIELD OF THE INVENTION

The invention relates to a capsule for preparing a beverage comprising a substantially rigid capsule body having a circumferential wall extending around an inner space of the capsule which is at least partially filled with a beverage ingredient suitable for preparing the beverage such as tea or coffee, and a base wall covering the inner space at a first end of the circumferential wall, the capsule comprising a lid covering the inner space at a second end of the circumferential wall opposite the base wall.

### BACKGROUND OF THE INVENTION

Such capsules for preparing a beverage are generally known from the prior art for use in a beverage preparation device wherein in a brewing chamber of the device liquid is injected in the capsule to extract the beverage from an extractable ingredient, usually roasted and ground coffee or tea, or to prepare the beverage from a soluble ingredient, usually instant coffee, instant tea or instant milk or chocolate-based product, contained within an inner space of the capsule.

In most of the known capsules the inner space of the capsule is hermetically or fluid-tightly closed from the environment prior to use in the beverage preparation device in order to maintain or prolong a freshness of the beverage ingredient during storage. The capsule hereto often comprises a substantially rigid capsule body having a circumferential wall extending around the inner space and a base wall covering the inner space at a first end of the circumferential wall. At a second end of the circumferential wall opposite the base wall the capsule body has an open filling side. A fluid tight lid is provided over the open filling side of the capsule body to cover the inner space. In use the capsule may be pierced, preferably at the base wall and/or the lid, to form an injection opening for injecting the liquid such as hot water, and/or to form an outlet opening which allows the prepared beverage to escape the capsule.

Many of the known capsules are particularly for preparing an espresso beverage wherein the injection of pressurized hot water in the capsule leads to an extraction of substances from the coffee beverage ingredient and with foam forming on the beverage corresponding to an espresso beverage with a crema layer as obtained with known piston type espresso machine using high pressure brewing.

For a crema-free coffee beverage, for example a coffee beverage without foam, also referred to as brewed coffee, usually apparatuses are used in which the beverage is prepared by unpressurized filtration of a mixture of beverage ingredient and water.

Also a tea beverage is usually prepared by unpressurized filtration of a mixture of beverage ingredient and water. The same applies to beverages prepared from soluble base products, or combinations of extractable and soluble base products.

There is however a need for capsules and systems with which such beverages like a crema-free coffee, a tea, milk or chocolate based beverage may be prepared in pressurized beverage preparation devices.

It is therefore an object of the invention to provide a capsule for preparing a crema-free coffee, a tea, milk or chocolate based beverage.

It is a further object of the invention to provide a system comprising a beverage preparation device and a capsule for preparing a crema-free coffee, a tea, milk or chocolate based beverage.

A particular object of the present invention is to provide such system and capsule for producing a crema-free coffee, a tea, milk or chocolate based beverage which has improvements over systems and capsules of the prior art. The crema-free coffee, tea, milk or chocolate based beverage obtained by the capsule and the system is preferably in quality similar to or improved as compared to crema-free coffee, tea, milk or chocolate based beverages prepared in prior art unpressurized filtration type of preparation apparatuses, particularly as perceived by the general public.

Another object of the invention is to provide a method of manufacturing a capsule suitable for preparing a crema free coffee, a tea, milk or chocolate based beverage.

### SUMMARY OF THE INVENTION

For that purpose, the invention provides a capsule as described herein. Also, the invention provides a system as described herein. Furthermore, the invention provides a method as described herein. Specific embodiments of the invention are described herein. The objects are achieved by the present invention, i.e. a capsule, and a system.

The capsule for preparing a crema-free coffee, a tea, milk or chocolate based beverage according to the invention comprises a substantially rigid capsule body having a circumferential wall extending around an inner space of the capsule which is at least partially filled with a beverage ingredient suitable for preparing the beverage, and a base wall covering the inner space at a first end of the circumferential wall, the capsule comprising a lid covering the inner space at a second end of the circumferential wall opposite the base wall, wherein a membrane is provided in the inner space of the capsule between the beverage ingredient and the lid, wherein the lid is provided with a preformed outlet opening suitable for draining the prepared beverage from the inner space when the capsule is used in a beverage preparation device, wherein the membrane extends at least over the surface of the outlet opening, which outlet opening is fluid tightly closed by a removable cover element extending over at least part of the lid. In prior art capsules the injection of water in the closed inner space leads to a build up of pressure until an outlet or outflow opening is created, e.g. by piercing the capsule body or lid or by a bursting open of part of the capsule body or lid under the build up pressure. The high brewing pressure prior to forming of an outflow opening results in more crema-forming compounds being extracted when an extractable ingredient is provided in the capsule. In addition to the pressure build up, the sudden pressure drop after creation of an outflow opening contributes to the formation of foam in the prepared beverage. The preformed outlet opening in the lid of the capsule according to the invention allows in use of the capsule in a beverage preparation device continuous escape of the prepared beverage from the capsule while water is injected. Accordingly the pressure build up and pressure drop at the outlet side of the prior art capsules which contribute to formation of a crema-layer are prevented in the capsule according to the invention. Thus the capsule of the invention is suitable for preparation in a pressurized beverage preparation device of a beverage having a reduced or no crema-layer. The preformed outlet opening in the lid is closed by the cover element in order to keep a hermetic sealing of the inner space of the capsule for maintaining or prolonging a freshness of the beverage ingredient in the capsule during storage. Prior to use in the beverage preparation device the cover element may be easily removed to free the outlet opening, for instance by manually tearing the cover element from the capsule. The preformed outlet opening is further covered by the membrane inside the inner space, which membrane may act as a filter to prevent solid particles of the beverage ingredient, for instance coffee grinds or tea leaves, from escaping the inner space through the outlet opening.

In a preferred embodiment of the capsule according to the invention the cover element is attached to the lid. For instance the cover element may be attached to a section of the lid surrounding the preformed outflow opening. As such the cover element may be sized to just cover the outflow opening without having to extend over the larger open filling side. This provides a saving on material costs. Additionally the lid and cover element may be conveniently premanufactured as an assembly which assembly can be attached to the capsule body in a single step, for instance by attaching the lid provided with the cover element to the end of the side wall. Also, when the lid has not yet been attached to the capsule body wherein it extends over the open filling side, it is easier to handle for attachment of the cover element to the lid in a correct manner over the preformed outflow opening. For instance the lid prior to attachment to the capsule body may be supported on a side in use facing the inner space to allow a force being exerted on the opposite side of the lid for attachment of the cover element, e.g. by applying a pressure step.

In a particular embodiment of the capsule according to the invention between the cover element and the lid a layer of adhesive material is provided suitable for a removable adhesion of the cover element to the lid. Particularly a suitable adhesive material may be selected in dependence on the materials used for the cover element and lid, wherein an adhesion strength between the cover element and lid is sufficient to keep the lid and cover element attached under normal circumstances while being easily overcome when a user applies a manual removal force on the cover element. The adhesive material is in a further particular embodiment of the capsule according to the invention a heat-seal lacquer. The lacquer may be used to obtain a suitable attachment with desired adhesion strength between the cover element and lid by heat and pressure bonding. The lacquer may be applied by a lacquering step either to an attachment surface of the lid or, preferably, an attachment surface of the cover element.

In a further preferred embodiment of the capsule according to the invention an adhesion strength between the layer of adhesive material and cover element is weaker than an adhesion strength between the layer of adhesive material and the lid. As such when the cover element is removed, e.g. by tearing of the cover element, the cover element will under normal circumstances tear away at the interface between the adhesive layer and the cover element thus maintaining an integrity of the capsule lid at all times. A determined outflow rate of the prepared beverage from the capsule through the preformed outlet opening with particular dimensions is hereby not affected.

In a further particular embodiment of the capsule according to the invention the layer of adhesive material is provided on a surface part of the cover element extending over the lid with a part of the cover element extending over the outlet opening in the lid being substantially free of adhesive material. The contents of the inner space, i.e. the beverage ingredient and extracted beverage, are herein not exposed to the adhesive material.

In a further preferred embodiment of the capsule according to the invention the lid with a circumferential edge portion thereof is attached to the capsule body. The lid may conveniently be glued, welded or otherwise attached to the capsule body, for example to the end of the side wall thereof.

The membrane provided between the beverage ingredient and the lid according to the invention particularly comprises a layer of non-woven material adapted to minimize formation of a crema layer. Particularly a weight, thickness and air permeability of the layer of non-woven material may be selected, preferably in dependence on each other, such to provide the layer with desired filtering capabilities for removing any crema forming components from the extracted liquid in the capsule. For instance the membrane may have a thickness of the layer in the range of 1.1 to 1.8 mm or 1.2-1.6 mm and/or the air permeability of the layer in the range of 100 – 700 mm/s measured at 200 Pa according to DIN and ISO 9237, and/or a weight of the layer in the range of 300-600 g/m2. A capsule according to the invention having such a membrane can be used for preparing a coffee beverage which does not or almost does not comprise crema. In particular a lungo or double lungo of brewed coffee can be prepared with such a capsule. A capsule according to the invention having such a membrane can also be used for preparing a tea, milk or chocolate based beverage.

The membrane may be provided loosely, unattached, in the inner space, wherein the membrane may rest on the beverage ingredient provided in the capsule. Alternatively the membrane may be attached with a circumferential edge portion to the capsule body. However, in a preferred embodiment of the capsule according to the invention the membrane is attached to the lid. Accordingly the membrane may be conveniently preassembled with the lid, and possible also with the cover element, prior to the attachment of such assembly to the capsule body for closing the open filling side. In the preassembly of the membrane and lid a correct alignment of the membrane with respect to the outlet hole may be easily achieved so that the entire outlet hole area may be covered with the membrane.

The membrane and lid in a particular embodiment of the capsule according to the invention may be attached by means of a layer of adhesive material, preferably a heat-seal lacquer. The heat-seal lacquer may be applied with a lacquering step to either the membrane or, preferably, the lid.

The cover element, lid and capsule body may be made of a wide variety of materials considered suitable by the skilled person and capable of being processed into a sheet, film or foil using techniques conventionally known in the art such as extrusion, co-extrusion, injection molding, blow molding, vacuum forming, etc. Suitable materials for the capsule body and/or lid and/or cover element include, without being limited thereto, plastic materials, in particular thermoplastic materials, for example a polyolefin polymer, for example polyethylene or polypropylene, PVC, polyesters for example polyethylene terephthalate (PET); metal foils such as aluminum, stainless steel, metal alloys etc. or sheets of a woven or a non-woven or otherwise processed fibrous material, like paper, polyester, etc.; or combinations thereof, e.g. multilayers. The material for the capsule can be a biodegradable polymer or another biodegradable material. The skilled person will be capable of selecting the appropriate material taking into account the envisaged use with food material and any other relevant circumstances during use of the capsule. The thickness of the sheet or foil may be chosen such that a form stable or substantially rigid capsule body is provided. The thickness of the sheet or foil may vary with the nature of the material.

In a further preferred embodiment of the capsule according to the invention the lid substantially consists of a sheet like layer of aluminum. The outlet opening may be provided in the lid by any appropriate means and method, such as punching or cutting one or more holes in the sheet with desired dimensions. The outlet opening is preferably provided in a central portion of the lid. In an alternative embodiment the outlet opening can be created at the moment of removing the removable cover element by the consumer. For example, the lid can comprise a perforation, preferably in a middle lid outlet region, which becomes exposed by removing the removable cover element. Alternatively, the lid can be provided with a material weakness, for example created by a laser scoring or a micro cut (e.g. like a partial cut used to make labels), preferably in a middle lid outlet region, which material weakness opens upon removal of the removable cover element thereby creating a perforation. As a further alternative the perforation can be provided in one or more layers in a laminate structure and remain in place with lamination adhesive, only being exposed on removing the removable cover element.

The preformed outlet opening in the lid is preferably circular. The preformed outlet opening in the lid may have a diameter of between 6 - 20 mm as an outlet opening with such diameter provides a sufficient exit area in the lid for the brewed beverage to escape the capsule without forming a substantial crema layer. Preferably the diameter of the outlet opening is between 8 - 14 mm. An outlet opening with a diameter of 12 mm is most preferred.

In another preferred embodiment of the capsule according to the invention the lid comprises on a side facing the cover element a layer of protective lacquer. The protective lacquer further supports a strength of the lid, and particularly protects an integrity thereof when the cover element is removed.

The cover element in a further preferred embodiment of the capsule according to the invention comprises a laminate of at least an aluminum layer and a plastic layer, preferable PE. The aluminum layer may be on a side of the cover element facing away from the capsule to provide the cover element a same feel when touched and aesthetic finish as the lid and capsule body made of aluminum. The PE layer may be on an opposite side of the cover facing the lid, which allows for application of a heat-seal lacquer thereto with a bond strength between the lacquer and PE layer being lower than a bond strength of the lacquer to the aluminum lid when the cover element is attached to the lid.

The cover element in another particularly preferred embodiment of the capsule according to the invention comprises a pull tab protruding from part of the cover element covering the outflow opening. At least a free end part of the pull tab opposite the end connected to the part of the cover element covering the outflow opening may be left unattached to the lid, so that a user may manually grasp the unattached part of the pull tab in order to easily remove the cover element from the lid by tearing the cover element off. The pull tab may to this end have any suitable size, e.g. length and thickness, and form for supporting a quick and easy removal of the cover element. Desired properties for the pull tab in order to remove the cover element from the lid will generally be known to the skilled person. Preferably at least part of the pull tab is angled with respect to a surface of the lid facing the cover element in order to allow for a more easy gripping of the pull tab by a user.

Most preferred, the capsule body, the lid, and the cover element are each mainly made from aluminum.

In a further particular embodiment of the capsule according to the invention the beverage ingredient in the inner space comprises an extractable product, such as roast and ground coffee or tea leaves.

In a further particular embodiment of the capsule according to the invention the beverage ingredient in the inner space comprises a soluble product, such as instant coffee, instant tea, instant milk or chocolate.

In a further particular embodiment of the capsule according to the invention the beverage ingredient in the inner space comprises a soluble product, such as instant coffee, instant tea, instant milk or chocolate product, in combination with an extractable product such as roast ground coffee or tea leaves.

In a further particular embodiment of the capsule according to the invention the beverage ingredient in the inner space comprises ground coffee in an amount of between 7-12 grams. Such a relatively large amount of ground coffee in the capsule allows for the preparation of a lungo or double lungo type of brewed coffee beverage without crema layer which has good organoleptic properties and sensory quality. Such a relatively large amount of ground coffee may for instance be provided in a particular embodiment of the capsule according to the invention with the capsule body having a relatively large size with relatively large inner space. For example the capsule according to the invention may have an inner space with a height dimension between the base wall and the lid of between approximately 30-45 mm, preferably between 38-42 mm, and a diameter of the inner space at the second end of the circumferential wall being approximately between 40-45 mm, preferably between 41-43 mm.

In another particular embodiment of the capsule according to the invention the beverage ingredient in the inner space comprises ground coffee in an amount of between 4-7 grams. Such amount of ground coffee in the capsule is particularly suitable for a faster preparation of a crema free coffee beverage of smaller volume, but with good organoleptic properties and sensory quality. Such an amount of ground coffee may for instance be provided in a particular embodiment of the capsule according to the invention with the capsule body having a relatively regular or smaller size with relatively regular or smaller inner space. For example in another particular embodiment of the capsule according to the invention the capsule has an inner space with a height dimension between the base wall and the lid in the order of approximately 26-30 mm, preferably between 28 - 29 mm and a diameter of the inner space at the second end of the circumferential wall being approximately between 34 – 40mm, preferably between 36-38 mm. Preferably, in this particular embodiment, the diameter of the outlet opening may be 12 mm or less, more preferably between 8 – 12 mm.

In a further particular embodiment of the capsule according to the invention the beverage ingredient in the inner space comprises tea leaves in an amount of between 1.5 - 5 grams. More particularly the capsule according to the invention may comprise 1.5 – 3 grams of tea leaves in a regular or smaller sized capsule body as described herein. The capsule according to the invention may also comprise 2.5 – 5 grams of tea leaves in a relatively large size capsule body as described herein.

In a further particular embodiment of the capsule according to the invention the beverage ingredient in the inner space comprises a soluble product, e.g. instant coffee, instant tea, milk powder or chocolate powder in an amount between 6-12 grams, preferably between 7-10 grams in a regular or smaller sized capsule body as described herein. The capsule according to the invention may also comprise between 10-20 grams, preferably between 12-18 grams, of soluble product in a relatively large size capsule body as described herein.

The system for preparing a beverage according to the invention comprises an exchangeable capsule and a beverage preparation device with a fluid dispensing device for feeding an amount of a fluid, such as water, under pressure to the capsule, and with a brew chamber, the brew chamber having a first brew chamber part for holding the capsule and a second brew chamber part for closing the brew chamber, wherein the exchangeable capsule comprises a substantially rigid capsule body having a circumferential wall extending around an inner space of the capsule which is at least partially filled with a beverage ingredient suitable for preparing the beverage, and a base wall covering the inner space at a first end of the circumferential wall, which base wall in use of the capsule in the beverage preparation device is pierced by at least one knife of the fluid dispensing device for feeding the amount of fluid, the exchangeable capsule comprising a lid covering the inner space at a second end of the circumferential wall opposite the base wall, wherein the lid has a preformed outlet opening suitable for draining the prepared beverage from the inner space when the capsule is used in the beverage preparation device, wherein the second brew chamber part comprises an extraction plate for engaging the exchangeable capsule at the second end of the circumferential wall when the brew chamber holding the capsule is closed, the extraction plate comprising a tearing surface for facing the lid of the capsule, wherein the lid of the exchangeable capsule in use in the closed brew chamber is not affected by the tearing surface. As the lid of the capsule is not affected by the tearing surface of the extraction plate, e.g. no tears or holes are provided in the lid by the extraction plate, the preformed outlet opening in the lid of the capsule determines the rate of prepared beverage escaping from the capsule in use. By providing an outlet opening dimensioned to this end, a beverage can thus be prepared with the system without pressure build up or sudden pressure drop occurring in the fluid flow. Formation of a crema-layer on the prepared beverage is hereby reduced. The preformed outlet opening in the lid is closed by a cover element in order to keep a hermetic sealing of the inner space of the capsule for maintaining or prolonging a freshness of the beverage ingredient in the capsule during storage. Prior to use in the beverage preparation device the cover element may be easily removed to free the outlet opening, for instance by manually tearing the cover element from the capsule.

In a preferred embodiment of the system according to the invention the beverage preparation device comprises a brew chamber in which additionally a capsule with closed lid can be used for preparing a further beverage. For instance the system may comprise a beverage preparation device with a brew chamber in which a capsule having a closed lid, without preformed outlet opening, may be used to prepare an espresso type of coffee beverage having a crema layer. The capsule with closed lid may be a known prior art capsule, such as a known espresso type capsule used in known capsule beverage machines. The capsule with closed lid is preferably a capsule with a capsule body similar to the capsule according to the invention and with the lid without opening being attached to the capsule body. In the capsules with closed lid in use in the brew chamber the injection of water will increase the internal pressure. Due to the internal pressure the closed lid may bulge outwardly to contact the tearing surface of the extraction plate. The tearing surface of the extraction plate of the beverage preparation device may comprise or be formed by a plurality of relief elements in order to, in use, tear the bulging lid of such capsule to form an outflow opening through which the prepared coffee beverage may escape the capsule. As in the capsule according to the invention there is in use in the brew chamber no build up of pressure inside the inner space the lid with preformed opening does not, or at least not sufficiently, bulge for contacting the tearing surface. The extraction plate of the beverage preparation device and the lid of the capsules may thus be adapted to each other such that capsules with a closed lid tear on the extraction plate whereas capsules with a lid having the preformed outlet opening do not tear on the extraction plate. The system according to the invention thus allows for using both capsules with closed lid, for instance for the preparation of a coffee beverage with crema layer, such as an espresso coffee, and capsules with a lid with preformed opening, for preparing a coffee beverage without crema layer, such as a brewed coffee. In addition the system according to the invention allows for using capsules with a lid with preformed opening for preparing a tea, milk or chocolate based beverage.

The extraction plate can include relief elements of a first type and at least one relief element of a second type. The relief element of the second type may have a sharper edge than the relief elements of the first type.

The method of manufacturing a capsule suitable for preparing a beverage according to the invention comprises:
providing a substantially rigid capsule body having a circumferential wall extending around an inner space to be at least partially filled with a beverage ingredient suitable for preparing the beverage, and a base wall covering the inner space at a first end of the circumferential wall,
filling the inner space with an amount of the beverage ingredient through an open filling side of the capsule body opposite the base wall, and
closing the open filling side by attaching a lid to the capsule body extending over the open filling side,
wherein the lid prior to the attachment to the capsule body is provided with an outlet opening through which in use a prepared beverage may flow out of the capsule, which outlet opening is fluid tightly closed by providing a removable cover element extending over the outlet opening and at least part of the lid.

In a preferred embodiment of the method of manufacturing a capsule according to the invention the removable cover element is attached to the lid prior to attaching the lid to the capsule.

In a further preferred embodiment of the method of manufacturing a capsule according to the invention a membrane is provided in the inner space after filling of the inner space with the beverage ingredient.

In a particularly preferred embodiment of the method of manufacturing a capsule according to the invention the membrane is attached to the lid prior to attaching the lid to the capsule.

### BRIEF DESCRIPTION OF THE DRAWING

These and other aspects of the present invention are hereinafter further elucidated by the appended drawing and corresponding embodiments, which form part of the present application. The drawing is not in any way meant to reflect a limitation of the scope of the invention, unless this is clearly and explicitly indicated. The exemplary embodiments are given by way of non-limitative illustration. It is noted that the figures are only schematic representations of embodiments of the invention that are given by way of non-limiting example.

In the drawing:

FIGS. 1A and 1B show a perspective side view of a first embodiment of a capsule according to the invention in respectively a closed storage state with attached cover element and open use state with the cover element removed;

FIG. 2 shows a top view of an embodiment of the capsule according to the invention.

FIG. 3 shows a perspective side view of a second embodiment of the capsule according to the invention in a closed storage state with attached cover element.

FIG. 4 shows a schematic representation of a laminated assembly of a cover element, lid and membrane for use in a capsule according to the invention.

### DETAILED DESCRIPTION

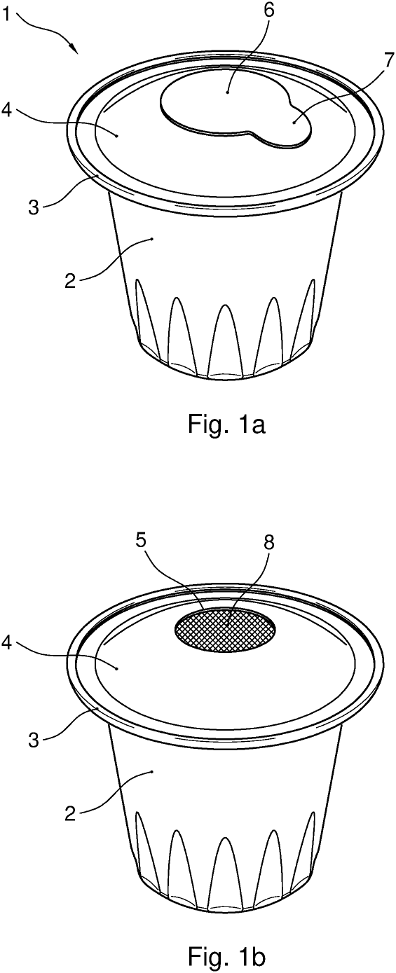

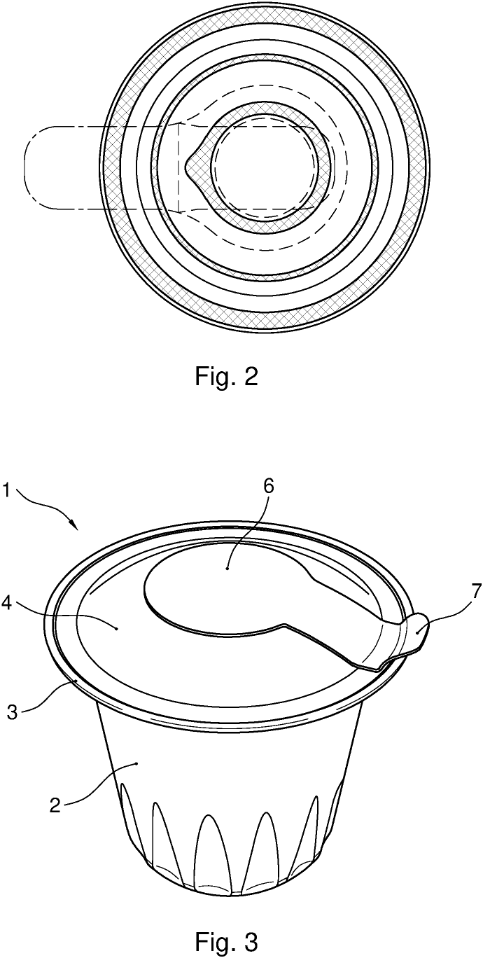

FIGS. 1A and 1B show a capsule according to the invention in a first embodiment. The capsule 1 comprises a capsule body 2. The body comprises a frusto-conical side wall extending around an inner space of the body. A base wall of the capsule body is connected to a first end of the side wall for closing off the inner space at the first end of the capsule body. A flange 3, also referred to as a rim, extends radially outwardly from a second end of the side wall. At the second end of the side wall the capsule body has an open filling side.

The capsule further includes a lid 4 that is attached to the flange 3 of the capsule body. The lid 4 is a relatively flexible sheet-like foil which is provided with a outflow opening 5 centrally located in the foil above the inner space. In the inner space a coffee bed of roast and ground coffee is provided. The weight of the coffee bed is in the range of 7-12 grams. In the storage state shown in FIG. 1A the capsule 1 is hermetically closed to maintain a freshness of the coffee bed. The outlet opening 5 is fluid tightly closed by a cover element 6 which is attached to the lid 4. In a use state of the capsule shown in FIG. 1B the cover element 6 is removed to free the outlet opening 5. For instance the cover element 6 may be manually removed from the lid by pulling on a pull tab 7 of the cover element 6. The base wall of the capsule body is further designed to be pierced open by piercing means of a beverage preparation device for supplying water under pressure into the capsule. A membrane 8 is provided in the inner space of the capsule between the coffee bed and the lid 4 below the preformed outflow opening 5. The capsule body 2, the lid 4, and the cover element 6 are each mainly made from aluminum. The lid 4, cover element 6 and membrane 8 prior to attachment to the capsule body 2 form a laminate with the cover element 6 attached to one side of the lid 4 extending over the preformed outlet opening, and the membrane 8 attached to the opposite side of the lid 4 extending over the preformed outlet opening.

FIG. 2 shows a top view of an embodiment of the capsule according to the invention in which a positioning of the lid, cover element, outlet opening and membrane with respect to each other is indicated. The outlet opening is provided in a central portion of the lid and has a circular shape. A diameter of the outlet opening may be between 6 - 20 mm, is preferably between 8 -14 mm and in a most preferred embodiment as shown in FIG. 2 a diameter of 12 mm. Further shown in FIG. 2 is that the cover element comprises a pull tab extending from the part of the cover element covering the outlet opening. The pull tab comprises a fold line for folding a loose part of the pull tab, i.e. part of the pull tab which is not attached to the lid, over part of the cover element attached to the lid and extending over the outlet opening.

FIG. 3 shows a capsule according to the invention in a second embodiment, which capsule differs from the capsule shown in FIG. 1 in that the cover element 6 comprises a longer pull tab 7 extending from the part of the cover element 6 covering the outlet opening 5 to the flange or rim 3 of the capsule body. A free end part of the pull tab 7 is loose, i.e. not adhered to the lid, and angled with respect to a surface of the lid so that a user may manually grasp this part of the pull tab in order to easily remove the cover element 6 from the lid by tearing the cover element off.

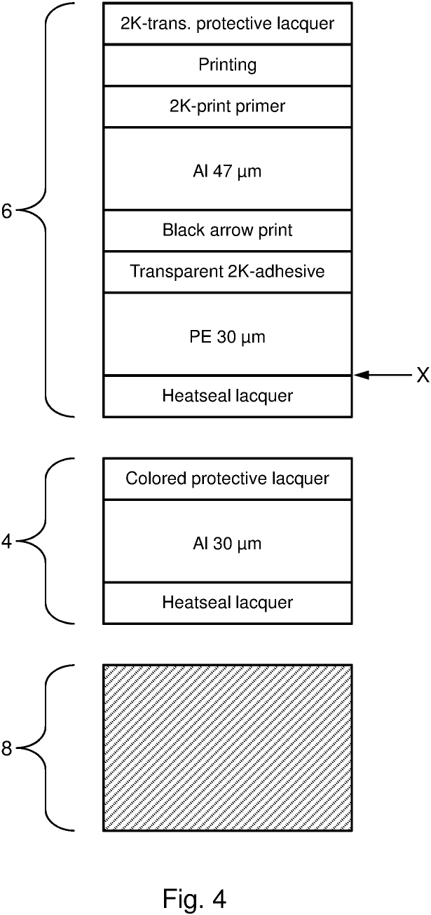

A detailed view of the laminated assembly of cover element, lid and membrane for use in a capsule according to the invention is shown in FIG. 4. The lid may be made of aluminum. The layer of aluminum may be in a range between 20-50 um and may particularly be between 30 um -40 um thick. As shown in FIG. 3 the lid 4 mainly consists of a layer of aluminum with a thickness of 30um. On both sides of the aluminum layer a lacquer layer is applied. On a side of the aluminum layer facing the cover element the lacquer layer is a protective lacquer. On the opposite side of the aluminum layer the lacquer layer is a heat seal lacquer for attaching the lid to the membrane 8 of non-woven material by means of heat and pressure bonding.

The cover element 6 comprises a layer of aluminum with a thickness of between 40-60 um, and is preferably 47um thick as shown. On one side of the aluminum layer facing the lid a print is applied which may be at least in part be visible to the user to provide information indicating how to suitably remove the cover element from the lid, e.g. arrows indicating a pull direction. A transparent adhesive layer is provided on this print layer for adhering a layer of polyethylene (PE). The PE layer may be 20 - 40 mm thick, and is preferably 30 mm thick as shown. The PE layer is lacquered with a heat seal lacquer for attaching the cover element 6 to the lid 4. The heat seal lacquer provides a weaker bond strength to the PE layer than to the aluminum lid, so that when a removal force is applied on the cover element, the cover element will tear at the PE layer and heat seal lacquer interface indicated with X. On the other side of the aluminum layer a print primer and further print layer is applied to provide an aesthetic finish to the cover element. A protective lacquer is provided at the visible outer surface of the cover element 6 facing away from the lid.

The membrane 8 comprises a layer of mainly polyester fibers with a thickness of 1.35 mm.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

In the examples, the capsule body and lid are made of aluminum foil, preferable polymer coated aluminum foil to allow easy welding of the lid to the body. It will be appreciated that the capsule body and/or lid can be made of a wide variety of materials considered suitable by the skilled person and capable of being processed into a sheet, film or foil using techniques conventionally known in the art such as extrusion, co-extrusion, injection molding, blow molding, vacuum forming, etc. Suitable materials for the capsule body and/or lid include, without being limited thereto, plastic materials, in particular thermoplastic materials, for example a polyolefin polymer, for example polyethylene or polypropylene, PVC, polyesters for example polyethylene terephthalate (PET); metal foils such as aluminum, stainless steel, metal alloys etc.; or sheets of a woven or a non-woven or otherwise processed fibrous material, like paper, polyester, etc.; or combinations thereof, e.g. multilayers. The material for the capsule can be a biodegradable polymer or another biodegradable material. The skilled person will be capable of selecting the appropriate material taking into account the envisaged use with food material and any other relevant circumstances during use of the capsule. The thickness of the sheet or foil may be chosen such that a form stable capsule is provided. The thickness of the sheet or foil may vary with the nature of the material.

In the examples, the capsules are pierced by the piercing means. It is also possible to provide the system with a capsule that is not pierced by the piercing means. Such capsule can e.g. include an entrance filter.

In the examples, the capsule has an outwardly extending flange-like rim to which the lid is attached. It will be appreciated that it is possible that the capsule does not include an outwardly extending rim.

1-22. (canceled)

23. A method of manufacturing a capsule suitable for preparing a beverage, wherein the method comprises:
providing a substantially rigid capsule body having a circumferential wall extending around an inner space to be at least partially filled with a beverage ingredient suitable for preparing the beverage, and a base wall covering the inner space at a first end of the circumferential wall;
filling the inner space with an amount of the beverage ingredient through an open filling side of the capsule body opposite the base wall;
after filling of the inner space with the beverage ingredient, closing the open filling side by attaching a lid to the capsule body, the lid extending over the open filling side; and
prior to attaching the lid to the capsule body:
providing the lid with an outlet opening through which in use a prepared beverage may flow out of the capsule,
fluid tightly closing the outlet opening by providing a removable cover element extending over the outlet opening and at least part of the lid, and
attaching a membrane to the lid over the outlet opening.

24. The method according to claim 23, wherein between the cover element and the lid a layer of adhesive material is provided suitable for a removable adhesion of the cover element to the lid.

25. The method according to claim 24, the method comprising providing the layer of adhesive material on a part of the cover element extending over the lid, and maintaining a part of the cover element extending over the outlet opening in the lid substantially free of adhesive material.

26. The method according to claim 24, wherein an adhesion strength between the layer of adhesive material and cover element is weaker than an adhesion strength between the layer of adhesive material and the lid.

27. The method according to claim 24, wherein the adhesive material is a layer of heat-seal lacquer.

28. The method according to claim 23, wherein the step of attaching the lid to the capsule body comprises attaching the lid to the capsule body at a circumferential edge of the capsule body.

29. The method according to claim 23, wherein the membrane comprises a layer of non-woven material.

30. The method according to claim 29, wherein the membrane comprises a thickness in the range of 1.2-1.6 mm, an air permeability in the range of 100 to 700 mm/s at 200 Pa, and a weight in the range of 300-600 g/m2.

31. The method according to claim 23, wherein the membrane is attached to the lid on a side of the lid facing the inner space.

32. The method according to claim 23, wherein the membrane and lid are attached by means of a layer of adhesive material, preferably a heat-seal lacquer.

33. The method according to claim 23, wherein the cover element comprises a sheet like layer of aluminum.

34. The method according to claim 33, wherein the cover element comprises a laminate of at least an aluminum layer and a plastic layer, particularly PE.

35. The method according to claim 23, wherein the lid substantially consists of a sheet like layer of aluminum.

36. The method according to claim 23, wherein the lid comprises on a side facing the cover element a layer of protective lacquer.

37. The method according to claim 23, wherein the cover element comprises a free pull tab protruding from part of the cover element covering the outlet opening.

38. The method according to claim 23, wherein the capsule body, the lid, and the cover element are each mainly made from aluminum.

39. The method according to claim 23, wherein the beverage ingredient comprises ground coffee in an amount of at least 7 grams.

40. A method of manufacturing a capsule suitable for preparing a beverage, wherein the method comprises:
preassembling a lid assembly comprising a lid having a preformed outlet opening, a removable cover element fluid tightly covering the outlet opening on one side of the lid, and a membrane covering the outlet opening on the opposite side of the lid;
providing a substantially rigid capsule body having a circumferential wall extending around an inner space to be at least partially filled with a beverage ingredient suitable for preparing the beverage, and a base wall covering the inner space at a first end of the circumferential wall;
filling the inner space with an amount of the beverage ingredient through an open filling side of the capsule body opposite the base wall;
after filling of the inner space with the beverage ingredient, closing the open filling side by attaching the preassembled lid assembly to the capsule body.

41. The method of claim 40, wherein the outlet opening is provided in a central portion of the lid and has a circular shape.

42. A method of manufacturing a capsule suitable for preparing a beverage, wherein the method comprises:
providing a substantially rigid capsule body having a circumferential wall extending around an inner space to be at least partially filled with a beverage ingredient suitable for preparing the beverage, and a base wall covering the inner space at a first end of the circumferential wall;
filling the inner space with an amount of the beverage ingredient through an open filling side of the capsule body opposite the base wall;
after filling of the inner space with the beverage ingredient, closing the open filling side by attaching a preassembled lid assembly to the capsule body, the preassembled lid assembly comprising a lid having a preformed outlet opening, a removable cover element fluid tightly covering the outlet opening on one side of the lid, and a membrane covering the outlet opening on the opposite side of the lid.
